(19) United States
(12) Patent Application Publication
(10) Pub. No.: US 2001/0039585 A1
(43) Pub. Date: Nov. 8, 2001

(54) System and method for directing a client to a content source

(76) Inventors: Leonard Primak, New York, NY (US); John Gnip, Rego Park, NY (US); Gene R. Volovich, Old Greenwich, CT (US)

Correspondence Address: C. Andrew Im, Esq., FULBRIGHT & JAWORSKI L.L.P., 666 Fifth Avenue, New York, NY, 10103, US

(21) Appl. No.: 09/730,152

(22) Filed: Dec. 5, 2000

Related U.S. Application Data
(63) Continuation-in-part of application No. 09/565,259, filed on May 5, 2000.
(60) Provisional application No. 60/245,025, filed on Nov. 1, 2000.
(60) Provisional application No. 60/169,196, filed on Dec. 6, 1999.

(51) Int. Cl. G06F 15/16; G06F 15/173

(52) U.S. Cl. 709/228; 709/245; 709/224

(57) ABSTRACT

A system for directing a client connection request to one of several server clusters associated with a content source. The system has a communication module for receiving a content source identifier from a client looking to access a specific content source, and a data table containing pointers to server clusters associated with the desired content source. The server clusters each transmit to the system information regarding their available capacity and connection quality with the client. In response to client's request, the system chooses and transmits to the client a pointer pointing to a server cluster whose associated available capacity exceeds a first threshold value and whose client connection quality exceeds a second threshold value.

### RELATED APPLICATION

This application is a continuation-in-part of U.S. provisional patent application Ser. No. 60/245,025 filed on Nov. 1, 1999 and continuation-in-part of U.S. patent application Ser. No. 09/565,259, filed May 5, 2000, which is a continuation-in-part of U.S. provisional patent application Ser. No. 60/169,196, filed Dec. 6, 1999, which is incorporated herein by reference in its entirety.

### FIELD OF THE INVENTION

The present invention generally relates to a system and method of directing connections between a client and a server in a distributed client server environment. More specifically, the invention relates to a domain name server that includes load balancing and connection quality evaluations.

### BACKGROUND OF THE INVENTION

An ever-increasing volume of requests for content through the Internet and other distributed computer networks has necessitated the use of large server farms by heavily accessed content sources, specifically popular World Wide Web sites (e.g., www.yahoo.com). It is common for a content source, such as a web site, to utilize many of these server farms, each housed in a separate facility and often located in different cities. Utilizing geographically diverse facilities to house replicated server farms has the benefit of; (1) improved time to access for client's near a facility, and (2) increased likelihood of failure recovery in the event of a disaster such as fire, flood, earthquake or lost connectivity.

Server farms are typically comprised of multiple servers and server clusters. A server farm sometimes is divided into several server clusters, where each cluster is associated with a different content source. For example, a smaller web site, outsourcing hosting operations to a hosting company, will contract for the use of one or more server clusters within the hosting company's server farm. Other content sources, however, may also have server clusters within the same farm. Many hosting companies maintain replicated server farms in different cities throughout the world, thereby providing their clients with the aforesaid advantages.

Each server cluster, associated with a common site or content source, has its own unique Internet Protocol address (“IP address”). In order for a client to access a content source, such as a web site, they require knowledge of the IP address of at least one of the server clusters associated with the site. To obtain an IP address, the client enters the domain name or some other identifier of the site into a web browser, usually in the format www.<domain-name>.<suffix>. The browser then sends the identifier to a shared lookup resource known as a Domain Name Server (“DNS”). The message sent by the web browser to the DNS is termed a “client domain resolution request” (“CDRR”). In response to a CDRR, the DNS transmits to the client the IP address of the identified site. If the DNS doesn't have an entry for the requested site, then the DNS replies with the IP address of another DNS which may have the requested IP address.

Conventional DNS use a data table storing the IP addresses of server clusters associated with each of the sites registered with the DNS. If a DNS receives a request for a site having multiple server clusters, the data table maps the site identifier (i.e., site domain name) to the IP address of each of the clusters. When faced with a multiple server cluster situation, many DNS of the prior art use a round robin procedure to select one of the IP addresses for transmission back to the client. That is, such DNS cycles through the list of IP addresses for the requested site, choosing a consecutive server cluster IP address each time a client requests the site. Other, more advanced DNS attempt to balance the connection load between the multiple server clusters by transmitting to the client the IP address of the cluster having the greatest available capacity to accept a connection. However, none of the DNS of the prior art consider the quality of possible connections between the client and the available server clusters when attempting to balance the connection load between the server cluster. As a result, DNS of the prior art can transmit to a client the IP address of a sever cluster having only marginal connection quality, while ignoring other clusters that can provide the client with a superior connection. Hence, in accordance with an embodiment of the present invention, the system measures the connection quality between a client and a server cluster in terms of two characteristics: the time it takes for data packets to travel from point to point, and the error rate.

### OBJECT AND SUMMARY OF THE INVENTION

Therefore, it is an object of the present invention to overcome the shortcomings of the prior art system.

Another object of the present invention is to provide a Domain Name Server that determines the IP address to transmit to a client as a function of the quality of a connection between the client and each server cluster.

A further object of the present invention is to provide a Domain Name Server as aforesaid, which directs a client to a server cluster as a function of the available capacity on each cluster.

In accordance with an embodiment, the present invention provides a system and method for directing a client to a server or cluster of servers having the client's desired or requested content source. A client transmits to a networked computational device a content source identifier indicating a desired content source. The networked computational device has a data table containing at least one pointer, each pointer points to a server or server cluster associated with the client's content source identifier. If more than one pointer in the table is associated with the client's site identifier (i.e., there is more than one replicated server cluster associated with the content source identified), then the present invention selects and transmits to the client a pointer to a server or server cluster having sufficient available capacity and suitable client connection quality to provide the client with the desired content.

In the context of the Internet and other distributed computer networks, the present invention is referred to as a Domain Name Server (“DNS”) and the content source identifier as a URL (e.g., www.warpsolutions.com) or a client name resolution request. In accordance with an aspect of the present invention, the server clusters intermittently transmit to the DNS a value representing their available capacity to accept connections from the client. Each server cluster also transmits to the DNS a value representing the connection quality between itself and each client that the DNS has referred to that cluster in the past. When the DNS receives a URL or a name resolution request, it chooses and transmits to the client the IP address of the server cluster matching the client's request. In cases where more than one cluster matches the client's request, the DNS chooses and transmits the IP address of the cluster best suited to handle the client's request. In determining which is the best server cluster to process or handle the client's request, the DNS evaluates the available capacity and the client connection quality for each of the server clusters.

Various other objects, advantages, and features of this invention will become readily apparent from the ensuing detailed description and the appended claims.

### BRIEF DESCRIPTION OF THE FIGURES

The following detailed description, given by way of example, and not intended to limit the present invention solely thereto, will best be understood in conjunction with the accompanying drawings:

FIG. 1 is a diagram illustrating a distributed computer network incorporating a DNS of the present invention;

FIG. 2 is a diagram illustrating an embodiment of DNS and server clusters in accordance with the present invention;

FIG. 3 is a diagram illustrating a client establishing a connection with a server cluster;

FIG. 4 is a diagram illustrating an operation of the DNS in accordance with an embodiment of the present invention;

FIG. 5 is a diagram illustrating an operation of the DNS in accordance with an embodiment of the present invention;

FIG. 6 is a diagram illustrating a client establishing a connection with a server cluster; and

FIG. 7 is a diagram illustrating various information flow between a client, the DNS and the sever clusters.

### DETAILED DESCRIPTION OF THE INVENTION

The present invention is readily implemented using presently available communication apparatuses and electronic components. The invention finds ready application in private or public communication networks, including but not limited to a wireless network, a satellite network, a cable network or any other form of network capable of transporting data locally or globally.

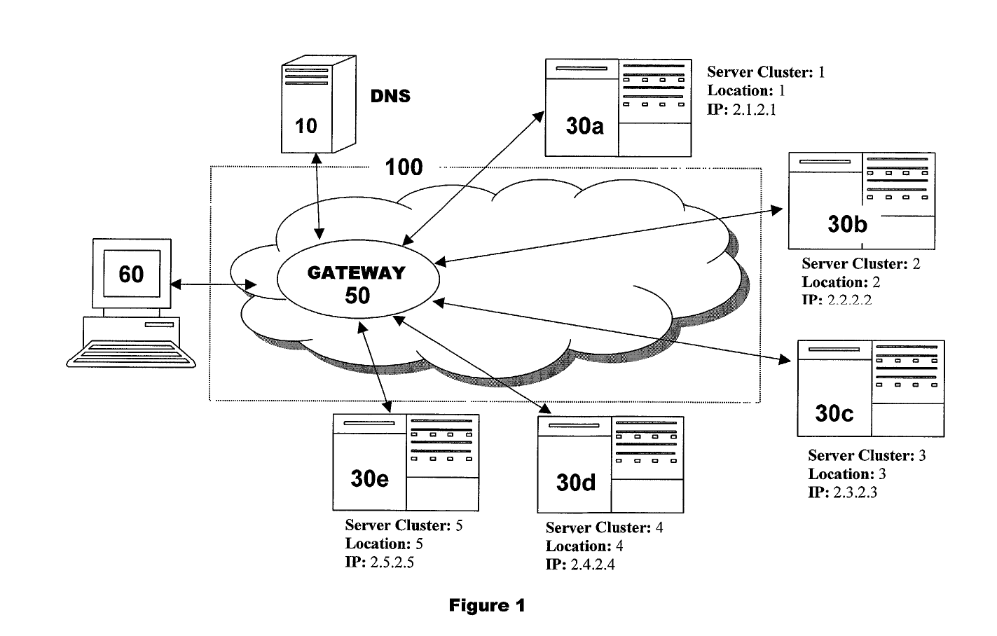

Turning now to FIG. 1, there is illustrated an example of a distributed computer network 100, such as the Internet, incorporating a Domain Name Server (DNS) of the present invention and content sources 30. A client 60 accesses content from one of the content sources 30 organized into five separate server clusters 30a-30e over the distributed computer network 100. Each of the server clusters 30a-30e stores substantially identical content. The client 60 is connected to the distributed computer network 100 through a gateway 50, such as an Internet Service Provider (ISP) or a router connected to the client's local area network (LAN). Although, the DNS 10 is shown as a separate device and apart from the server clusters 30a-30e in FIG. 1, the DNS 10 can alternatively reside in the same facility as one of the server clusters 30a-30e. It is appreciated that each element shown in FIG. 1, including the gateway 50 and the server clusters 30a-30e, has a unique IP address.

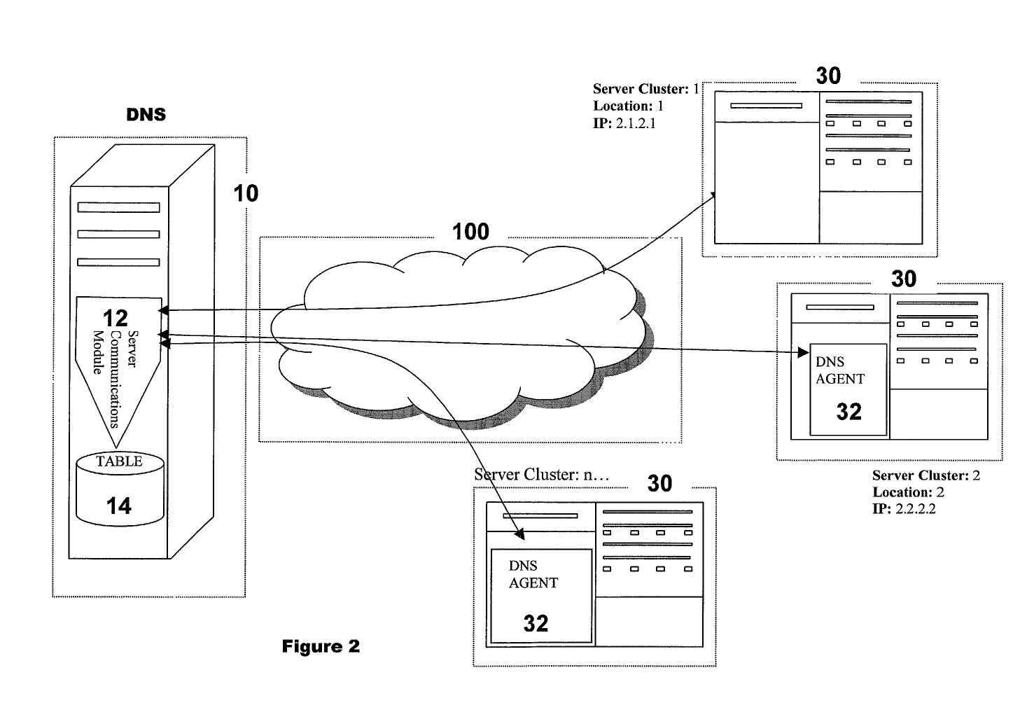

FIG. 2 illustrates an embodiment of the DNS 10 of the present invention comprising a communications module 12 and a data table 14, and an embodiment of the server clusters 30 of the present invention, each server cluster 30 comprising a DNS agent 32 residing in one or more servers therein. The communications module 12 of the DNS 10 communicates with the DNS agents 32 via the distributed computer network 100. Preferably, each DNS agent 32 transmits the available capacity of its associated server cluster 30, to the communications module 12. The communications module 12 stores the available capacity information in the data table 14 of the DNS 10. That is, each time the communications module 12 receives new capacity information from a DNS agent 32, the data table 14 is updated accordingly. Alternatively, the DNS agents 32 periodically transmit the new capacity information, such as every minute, every 5 minutes, etc. Preferably, the frequency of the updates form the DNS agents 32 is configurable and can be negotiated between each DNS agent 32 and the communications module 12.

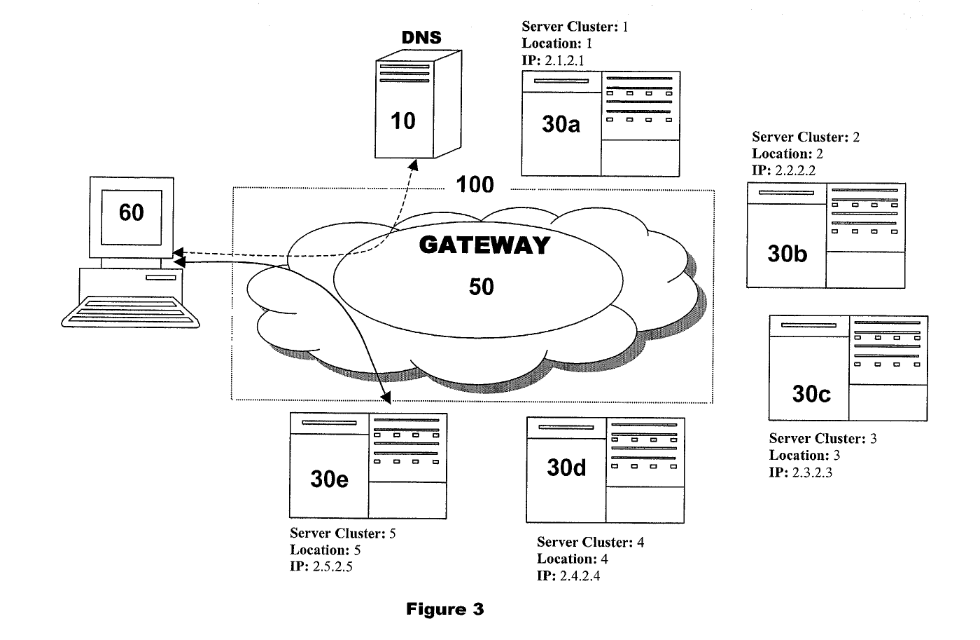

FIG. 3 illustrates an example of how a client 60 establishes a connection with one of the server clusters 30. A client 60 transmits or sends a domain resolution request (or a “client query”) to the DNS 10 for the IP address of a server cluster 30. In response to the request, the DNS 10 provides the client 60 with a pointer to the server cluster 30e, i.e., the server cluster having the greatest available capacity to accept a request or based on the client connection value (as described herein). After receiving the IP address of the server cluster 30e from the DNS 10, the client 60 initiates a connection with the server cluster 30e.

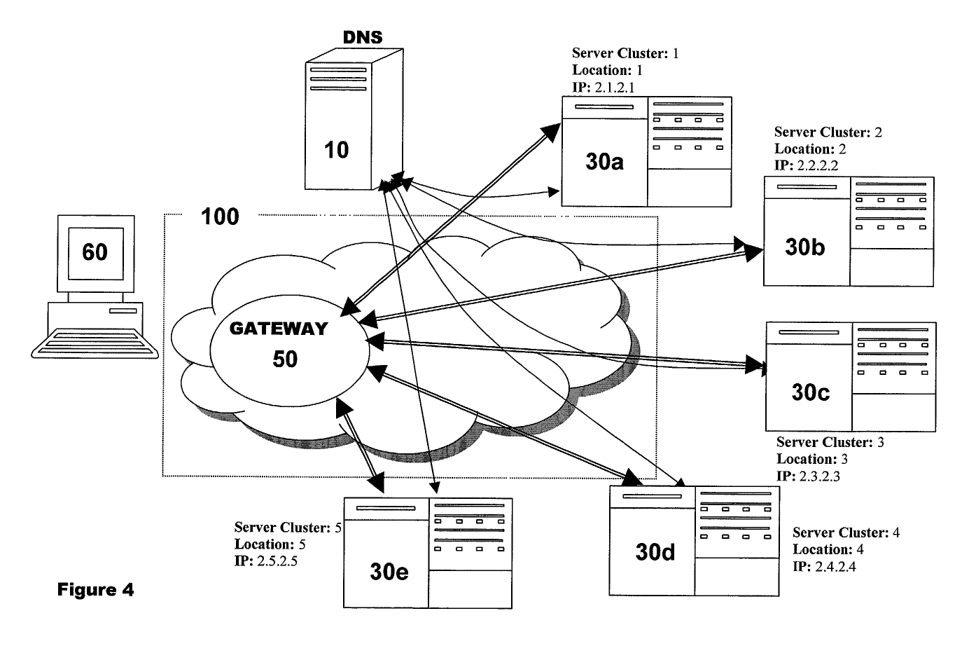

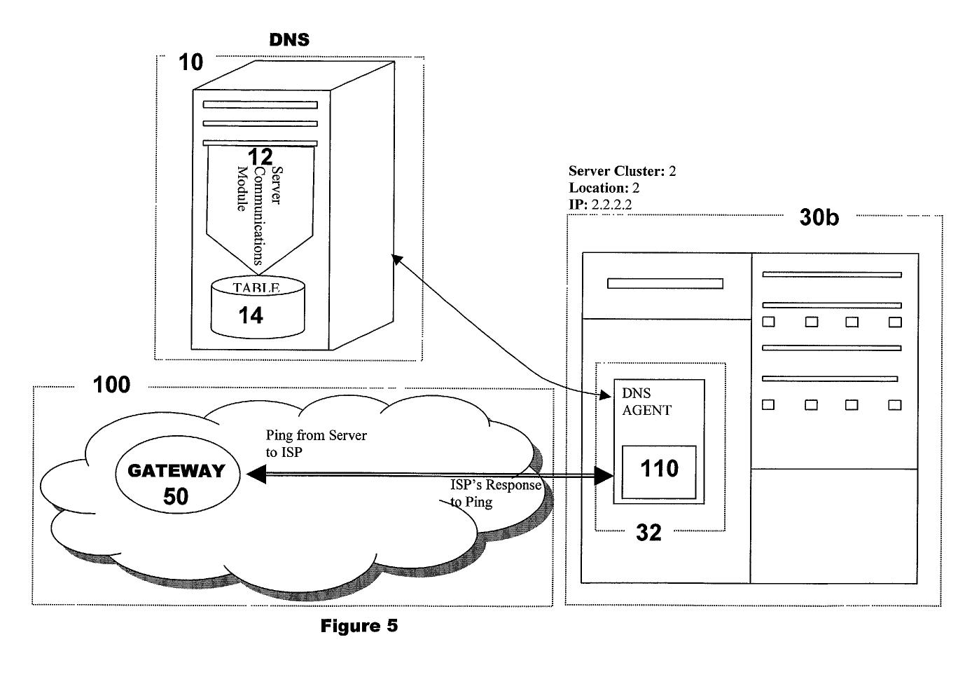

In accordance with an embodiment of the present invention, when a client 60 transmits an initial domain resolution request to the DNS 10 for the IP address of a server cluster 30 corresponding to a particular site, the DNS 10 communicates an instruction to obtain measurement statistics by transmitting a pinging instruction or a DNS query to the DNS agents 32 on each of the associated server clusters 30, as shown in FIG. 4 or to a DNS agent on a particular server cluster 30b, as shown in FIG. 5. Preferably, the DNS agents 32 comprises a query control module 110 for encapsulating information about the transport or protocol used to transmit a DNS query and receive its corresponding response, such as the server cluster's available capacity and connection quality, the IP address of the client's gateway 50, etc. The DNS 10 constructs the DNS query, containing the transport information, upon receipt of the client query and transmitted to the all of the DNS agents 32 or a subset of DNS agents 32 based on the location of client 60 or server cluster zone. The distributed network 100 of the present invention can utilize various protocol or transport mechanism to transmit the DNS queries, such as the uniform datagram protocol (UDP), transmission control protocol/internet protocol (TCP/IP), or master/slave protocol. The UDP is a TCP/IP protocol that provides very few error recovery services, offering instead a direct way to send and receive datagrams over an IP network. UDP is used primarily for broadcasting messages over a network. TCP/IP represents a suite of communications protocols used to connect hosts on the Internet and uses several protocols, the two main ones being TCP and IP.

TCP is a standard transport level protocol that provides the reliable, full duplex, stream service on which many application protocols depend. TCP allows a process or application on one server to send a stream of data to a process on another server.

The master/slave protocol is the transport protocol in which one device or server (the master) controls one or more other devices or servers (the slaves). Unlike the UDP and TCP/IP protocol, the master/slave protocol requires that the master device know the addresses of each slave device. Accordingly, the slave device must provide its address to the master device, so the master device can transmit its response to the appropriate slave device.

Returning to FIGS. 4 and 5, in response to the DNS query, each DNS agent 32 transmits a ping to the gateway 50 using the IP address of the gateway contained in the DNS query. The DNS agent 32 then waits for a response and records the time it takes for the ping to make a roundtrip or the roundtrip time (RTT). In accordance with an embodiment of the present invention, the ping sent by a DNS agent 32 consists of a series of data packets. Upon receipt, the gateway 50 retransmits the series of data packets to each originating DNS agent 32. The DNS agent 32 then evaluates the response to its ping to determine the error rate value for its client path, i.e., the connection between the gateway 50 and the server cluster 30 on which the originating DNS agent 32 resides (the server cluster and gateway combination). After a DNS agent 32 receives and evaluates the ping response, the DNS agent transmits the round-trip time and error rate value for the client path (collectively referred to herein as the “client connection value”) to the DNS 10.

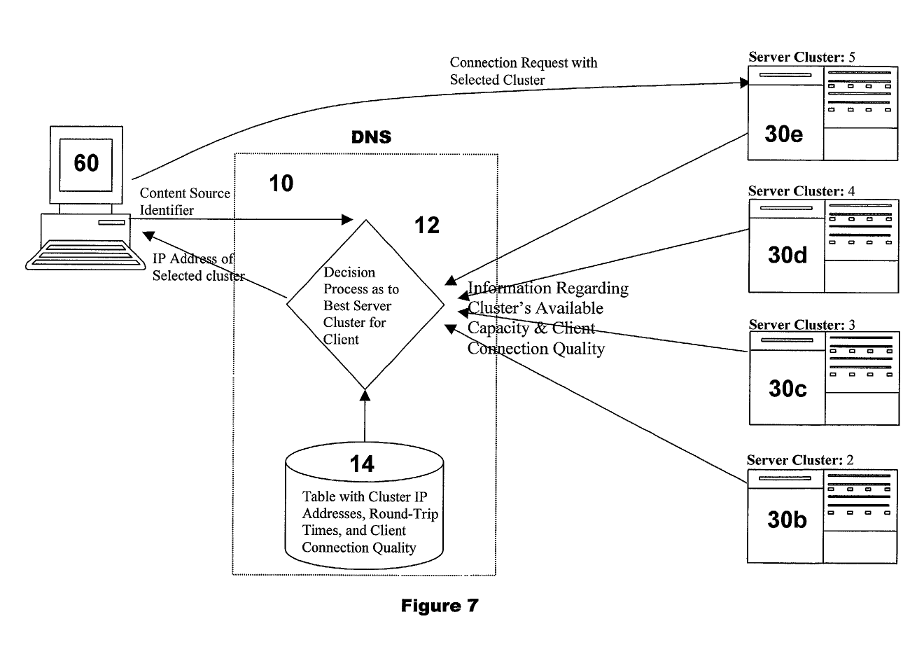

In accordance with an embodiment of the present invention, the DNS 10 stores the RTT and error rate value for each server cluster and client gateway combination along with the available capacity information in the data table 14 (FIG. 7). It is appreciated that the client connection value can be updated each time the DNS 10 receives a domain name request (i.e., URL) or can be updated periodically. For example, if the combination of the server cluster 30b and the gateway 50 results in the shortest round-trip time and lowest error rate, then DNS 10 provides IP address of the server cluster 30b to client 60 because the server cluster 30b has the best client connection value for the client's gateway 50.

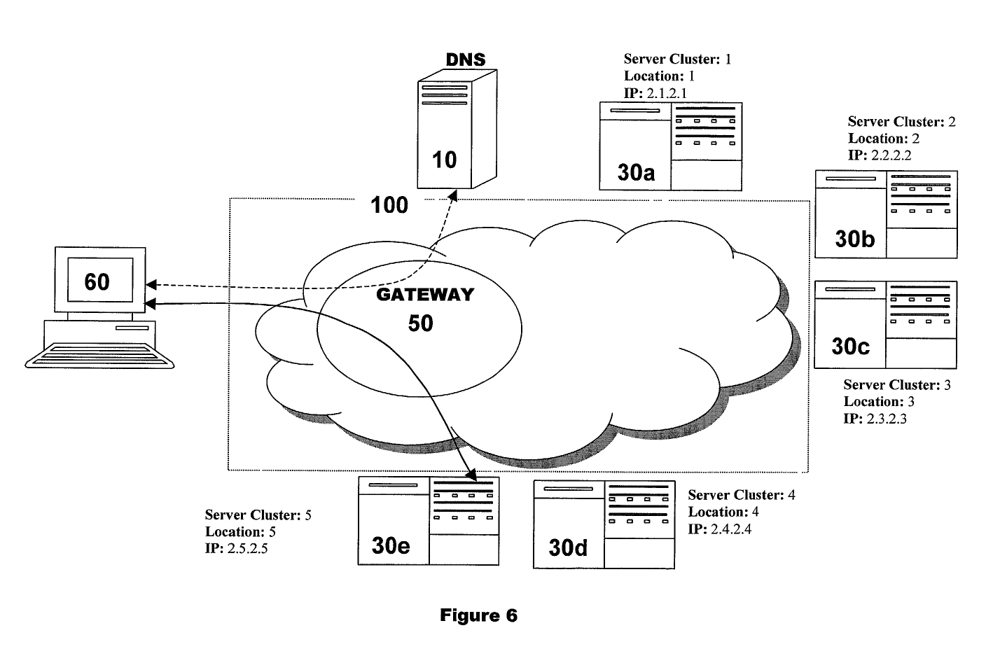

FIG. 6 provides an example of the client 60 connecting with the specific content source for a second time. As in the previous instance, the client 60 sends a domain resolution request to the DNS 10, requesting the IP address of a server cluster 30 associated with a desired web site. The DNS 10 can identify the client 60 based on the “source IP” address or value of the data packets which comprise the client's request. That is, the DNS 10 can compare the source IP address to the stored IP address to identify a returning customer, visitor or client.

Turning now to FIG. 7, there is illustrated an example of how the DNS 10 of the present invention determines the most suitable server cluster to process the client query. In determining which cluster 30 is best suited to handle a connection with a client 60, the DNS 10 can consider the factors, including but not limited to: (1) the available capacity of each of the associated server clusters 30; (2) the RTT for the data packets traveling from the client's gateway 50 and the server clusters 30; and (3) the error rates for these same data packets. The DNS 10 can direct the client 60 to an optimal server cluster 30 by transmitting to the client 60 a pointer pointing to a server cluster 30 whose associated available capacity value (i.e., value (1)) exceeds a first threshold value and whose client connection value (i.e., values (2) and (3)) exceed a second threshold value. It is appreciated that a particular weight assigned to each of these factors and the number of these factors to be considered in selecting the most suitable server cluster can be configured by a system operator, a web site owner/operator, etc. In this example, the DNS 10 determines that server cluster 30a is best suited to handle a connection with the client 60. In response to its domain resolution request, the client 60 receives the IP address of server cluster 30a, and the client 60 attempts to make this connection.

While the present invention has been particularly described with respect to the illustrated embodiment, it will be appreciated that various alterations, modifications and adaptations may be made on the present disclosure, and are intended to be within the scope of the present invention. It is intended that the appended claims be interpreted as including the embodiment discussed above, those various alternatives, which have been described, and all equivalents thereto.

What is claimed:

1. A method of directing a client to a content source over a network, comprising the steps of:
receiving a domain resolution request from a client over said network;
selecting a server cluster from a plurality of server clusters as a function of connection qualities between said client and each server cluster; and
connecting said client to said selected server cluster.

2. The method of claim 1, further comprising the steps of determining the connection quality of said client with each of said plurality server clusters; and storing said connection qualities in a domain name server.

3. The method of claim 2, wherein the step of receiving receives said request from said client over a gateway; and wherein the step of determining the connection quality includes the steps of:
pinging the gateway over said network by each server cluster to determine a roundtrip time between the gateway and said server cluster;
determining an available capacity of each server cluster; and
determining the connection qualities between said client and each server cluster as a function of the roundtrip time and the available capacity.

4. The method of claim 3, wherein the step of determining the connection quality further includes the steps of:
pinging the gateway over said network by each server cluster to determine an error rate between the gateway and said server cluster; and
determining the connection qualities between said client and each server cluster as a function of the roundtrip time, the error rate and the available capacity.

5. The method of claim 2, wherein the step of receiving receives said request from said client over a gateway; and wherein the step of determining the connection quality includes the steps of:
pinging the gateway over said network by each server cluster to determine an error rate between the gateway and said server cluster;
determining an available capacity by each server cluster; and
determining the connection qualities between said client and each server cluster as a function of the error rate and the available capacity.

6. The method of claim 1, wherein the step of connecting includes the step of transmitting an IP address of said selected server cluster to said client over said network.

7. A system for directing a client to a content source over a network, comprising:
a plurality of server clusters connected to said network;
a plurality of clients connected to said network;
a domain name server, connected to said network, for receiving a domain resolution request from a client and selecting a server cluster from said plurality of server clusters as a function of connection qualities between said client and each server cluster; wherein said client is operable to connect with said selected server cluster.

8. The system of claim 7, wherein said domain name server comprises:
a communications module for determining the connection quality of said client with each of said plurality server clusters; and
a data table for storing said connection qualities.

9. The system of claim 8, further comprising a gateway connecting said client to said network; wherein each said cluster comprises a DNS agent for providing the connection quality of said client and an associated server cluster to said communications module.

10. The system of claim 9, wherein each DNS agent determines the connection quality of said client and an associated server cluster by determining the available capacity of an associated server cluster and pinging said gateway to determine a roundtrip time between said gateway and said associated server.

11. The system of claim 10, wherein each DNS agent is operable to determine the connection quality of said client and said associated server cluster by determining the available capacity of an associated server cluster and pinging said gateway to determine a roundtrip time and an error rate between said gateway and said associated server.

12. The system of claim 9, wherein each DNS agent determines the connection quality of said client and an associated server cluster by determining the available capacity of an associated server cluster and pinging said gateway to determine an error rate between said gateway and said associated server.

13. The system of claim 7, wherein said domain name server is operable to transmit an IP address of said selected server cluster to said client.
